(19) United States
(12) Patent Application Publication
(10) Pub. No.: US 2013/0064452 A1
(43) Pub. Date: Mar. 14, 2013

(54) APPARATUS AND METHOD FOR PROCESSING IMAGE FEATURE DESCRIPTOR

(71) Applicants: Yen-Chung CHANG, Hsinchu City (TW); Jiun-Yan Chen, Tuku Township (TW)

(72) Inventors: Yen-Chung CHANG, Hsinchu City (TW); Jiun-Yan Chen, Tuku Township (TW)

(21) Appl. No.: 13/601,978

(22) Filed: Aug. 31, 2012

(30) Foreign Application Priority Data
Sep. 14, 2011 (TW) 100133048

(51) Int. Cl. G06K 9/46

(52) U.S. Cl. 382/190

(57) ABSTRACT

An apparatus and a method for processing image feature descriptor are disclosed. The image feature descriptor processing apparatus comprises a header storing unit, a vector storing unit, a feature capture unit, a distribute unit, and a memory controller. The feature capture unit captures image feature descriptors. The distribute unit generates a header base address, a vector base address, headers, and vectors according to the image feature descriptors. The memory controller continuously writes the headers to the header storage unit according to the header base address and continuously writes the vectors to the vector storage unit according to the vector base address.

This application claims the benefit of Taiwan application Serial No. 100133048, filed Sep. 14, 2011, the disclosure of which is incorporated by reference herein in its entirety.

### BACKGROUND

1. Technical Field

The disclosed embodiments relate in general to an apparatus and a method for processing image feature descriptor.

2. Description of the Related Art

Referring to both FIG. 1 and FIG. 2. FIG. 1 shows a schematic diagram of conventional storage feature descriptors. FIG. 2 shows a schematic diagram of feature matching and a matching search window. The dynamic random access memory 11 sequentially stores the feature descriptors F1˜Fn, which describe n feature points 22 illustrated in FIG. 2, wherein, n is a positive integer. The feature descriptor F1 comprises a feature number FN1, feature coordinates FC1, an orientation O1 and a vector V1. The feature descriptor F2 comprises a feature number FN2, feature coordinates FC2, an orientation O2 and a vector V2. By the same analogy, the feature descriptor Fn comprises a feature number FNn, feature coordinates FCn, an orientation On and a vector Vn. The dynamic random access memory 11 sequentially stores the feature number FN1, the feature coordinates FC1, the orientation O1 and the vector V1 of the feature descriptor F1 and then sequentially stores the feature number FN2, the feature coordinates FC2, the orientation O2 and the vector V2 of the feature descriptor F2. By the same token, the dynamic random access memory 11 sequentially stores the feature number FNn, the feature coordinates FCn, the orientation On and the vector Vn of the feature descriptor Fn at last.

Before matching the features, the feature coordinates of a to-be-matched feature point 22 is read from the dynamic random access memory 11 to determine whether the to-be-matched feature point 22 falls within the matching search window 21. If so, the vector of the to-be-matched feature point 22 is then read from the dynamic random access memory 11 to perform feature matching.

### SUMMARY

The disclosure is directed to an apparatus and a method for processing image feature descriptors. With the headers and the vectors being stored to a header storage unit and a vector storage unit respectively, the read efficiency during feature matching is thus increased.

According to one embodiment, an image feature descriptor processing apparatus is provided. The image feature descriptor processing apparatus comprises a header storing unit, a vector storing unit, a feature capture unit, a distribute unit, and a memory controller. The feature capture unit captures image feature descriptors. The distribute unit generates a header base address, a vector base address, headers, and vectors according to the image feature descriptors. The memory controller continuously writes the headers to the header storage unit according to the header base address and continuously writes the vectors to the vector storage unit according to the vector base address.

According to another embodiment, an image feature descriptor processing method is provided. The image feature descriptor processing method comprises the steps of capturing image feature descriptors; generating a header base address, a vector base address, headers, and vectors according to the image feature descriptors; and continuously writing the headers to the header storage unit according to the header base address and continuously writing the vectors to the vector storage unit according to the vector base address.

### BRIEF DESCRIPTION OF THE DRAWINGS

FIG. 1 shows a schematic diagram of conventional storage feature descriptors;

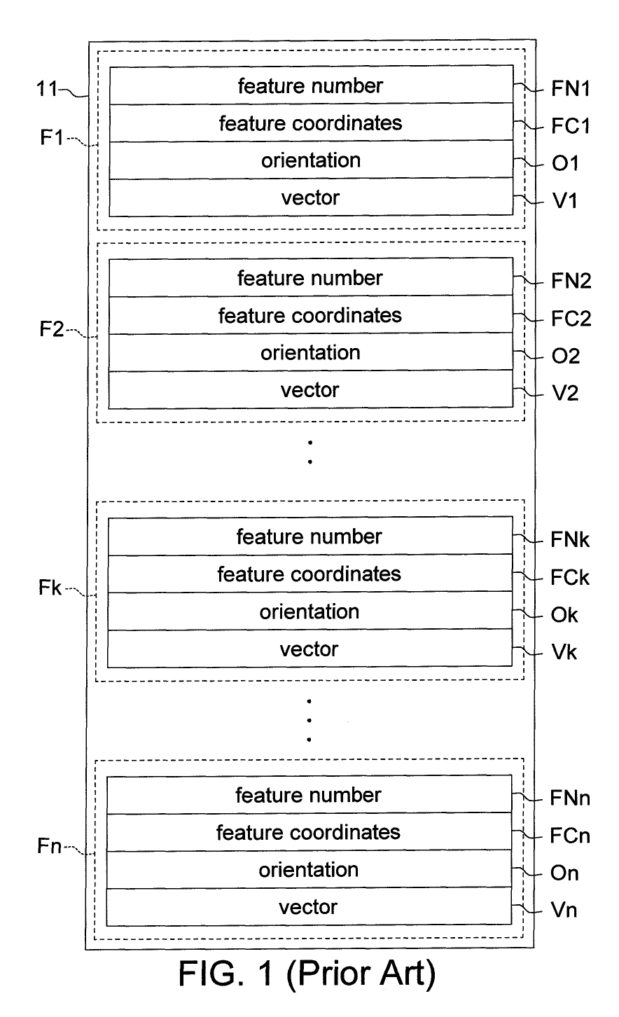

FIG. 2 shows a schematic diagram of feature matching and a matching search window;

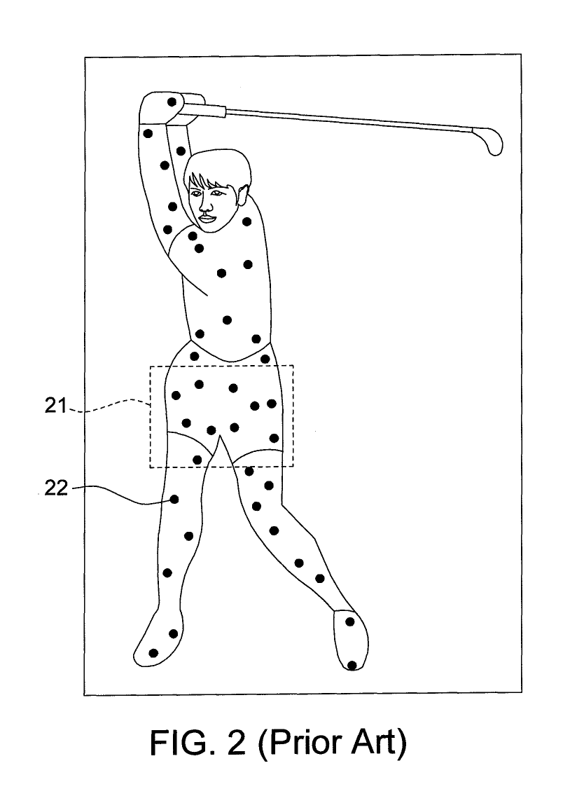

FIG. 3 shows a block diagram of an image feature descriptor processing apparatus according to a first embodiment;

FIG. 4 shows a schematic diagram of a header storage unit and a vector storage unit;

FIG. 5 shows a flowchart of a method for processing image feature descriptors according to a first embodiment;

FIG. 6 shows block diagram of an apparatus for processing image feature descriptors according to a second embodiment; and

FIG. 7 shows a flowchart of a method for processing image feature descriptors according to a second embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

### First Embodiment

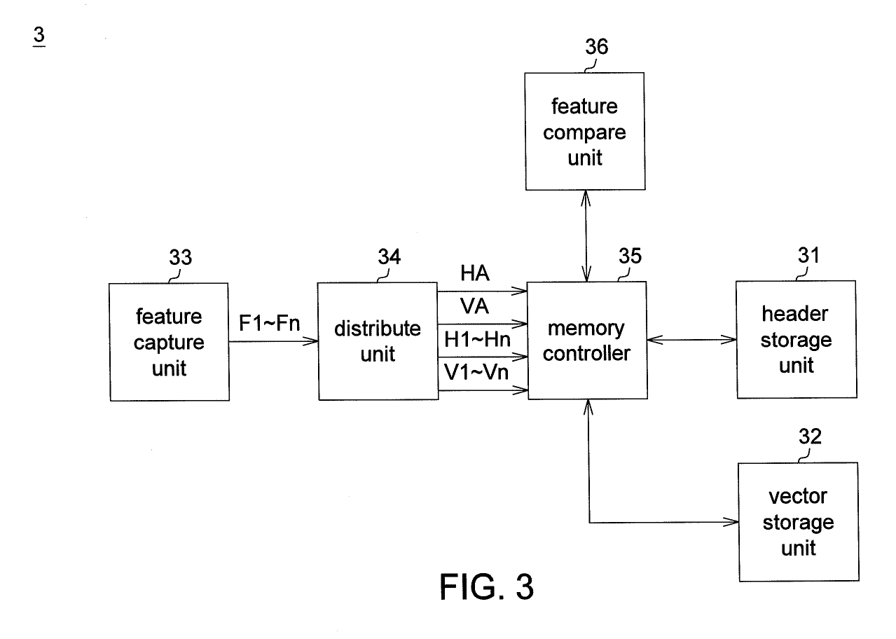

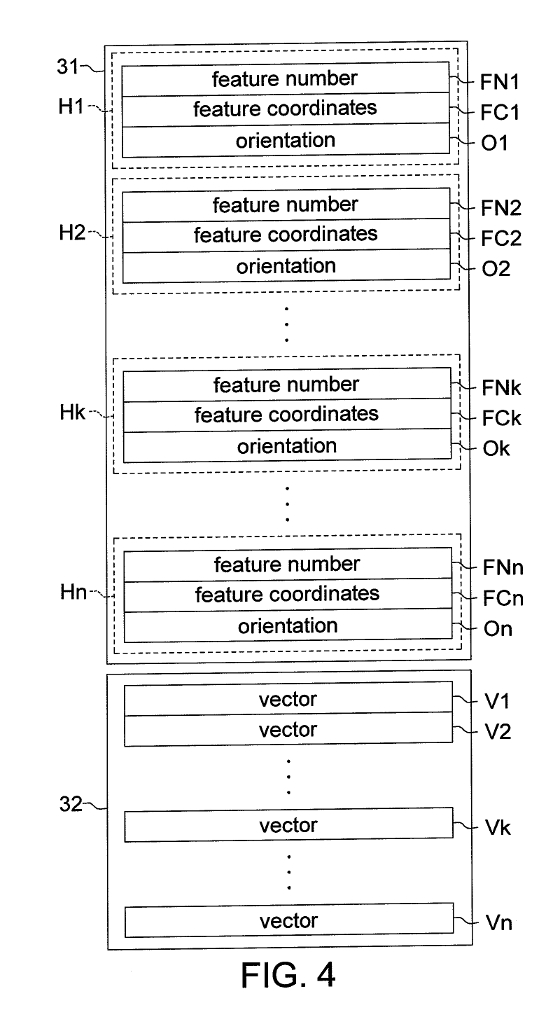

Referring to both FIG. 3 and FIG. 4. FIG. 3 shows a block diagram of an image feature descriptor processing apparatus according to a first embodiment. FIG. 4 shows a schematic diagram of a header storage unit and a vector storage unit. The image feature descriptor processing apparatus 3 comprises a header storage unit 31, a vector storage unit 32, a feature capture unit 33, a distribute unit 34, a memory controller 35 and a feature compare unit 36. The feature capture unit 33, the distribute unit 34 and the feature compare unit 36 are realized by such as a central processing unit, a digital signal processor (DSP) or a digital circuit. The distribute unit 34 can be further integrated to the feature capture unit 33 or the memory controller 35. The feature compare unit 36 can be further integrated to the feature capture unit 33.

The header storage unit 31 and the vector storage unit 32 can such as share the same dynamic random access memory (DRAM).

The feature capture unit 33 is coupled to the distribute unit 34. The memory controller 35 is coupled to the header storage unit 31, the vector storage unit 32, the distribute unit 34 and the feature compare unit 36. The feature capture unit 33 captures image feature descriptors F1˜Fn, wherein n is a positive integer. The feature capture unit 33 generates image feature descriptors F1˜Fn according to such as the scale invariant feature transform (SIFT) algorithm.

The distribute unit 34 generates a header base address HA, a vector base address VA, headers H1˜Fn and vectors V1˜Vn according to image feature descriptors F1˜Fn. The headers H1 comprises a feature number FN1, feature coordinates FC1 and an orientation O1. The feature descriptor F2 comprises a feature number FN2, feature coordinates FC2 and an orientation O2. By the same analogy, the feature descriptor Fn comprises a feature number FNn, feature coordinates FCn and an orientation On. Furthermore, the headers H1˜Hn can respectively comprise other information not belonging to the vectors V1˜Vn. In addition, the headers H1 can merely comprise the feature number FN1 and the feature coordinates FC1 but not the orientation O1.

The memory controller 35 continuously writes the headers H1˜Hn to the header storage unit 31 according to the header base address HA, so that the headers H1˜Hn are continuous in the memory address of the header storage unit 31. The memory controller 35 continuously writes the vectors V1˜Vn to the vector storage unit 32 according to the vector base address VA, so that the vector V1˜Vn are continuous in the memory address of the vector storage unit 32.

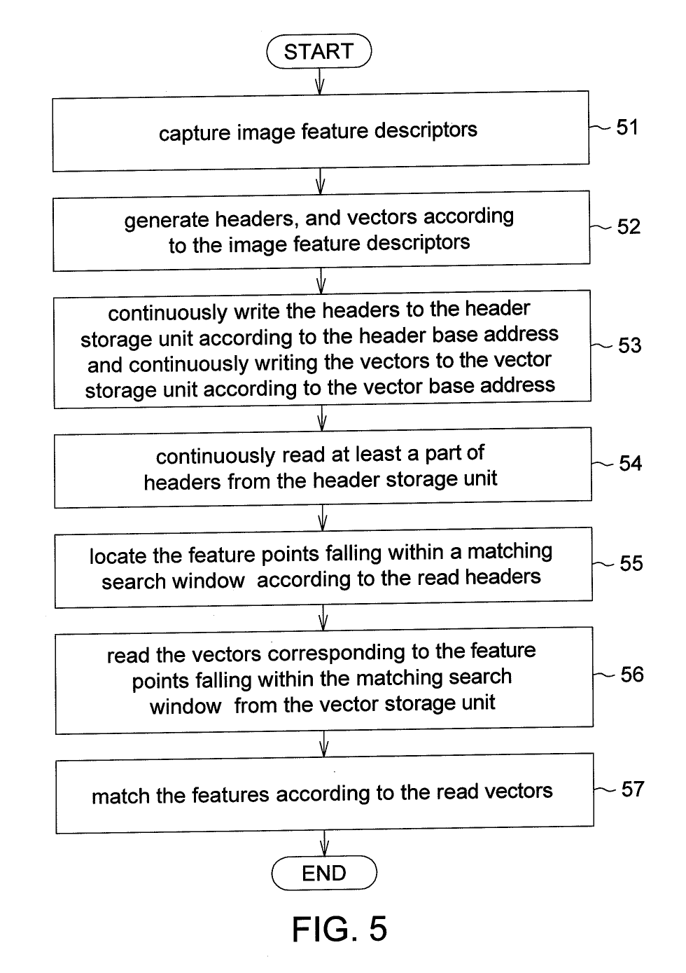

Referring to FIG. 3, FIG. 4 and FIG. 5. FIG. 5 shows a flowchart of a method for processing image feature descriptors according to a first embodiment. The image feature descriptor processing method, which can be used in the image feature descriptor processing apparatus 3, comprises the following steps: Firstly, as indicated in step 51, the feature capture unit 33 captures image feature descriptors F1˜Fn. Next, as indicated in step 52, the distribute unit 34 generates a header base address HA, a vector base address VA, headers H1˜Fn and vectors V1˜Vn according to the image feature descriptors F1˜Fn. Then, as indicated in step 53, the memory controller 35 continuously writes the headers H1˜Fn to the header storage unit 31 according to the header base address HA and continuously writes the vectors V1˜Vn to the vector storage unit 32 according to the vector base address VA.

Then, as indicated in step 54, the memory controller 35 continuously reads at least a part of headers from the header storage unit 31. Then, as indicated in step 55, the feature compare unit 36 locates the feature descriptors falling within a matching search window according to headers H1˜Fn. Then, as indicated in step 56, the memory controller 35 reads the vectors of the feature descriptors falling within the matching search window from the vector storage unit 32. Then, as indicated in step 57, the feature compare unit 36 performs feature matching according to the vectors of the feature descriptors falling within the matching search window. Since the image feature descriptor processing apparatus 3 can continuously read at least a part of headers, the time for reading the headers is thus reduced and the feature matching speed is increased accordingly. When the present embodiment is used in a dynamic random access memory which has superior efficiency in continuous access, the overall feature matching speed is increased.

### Second Embodiment

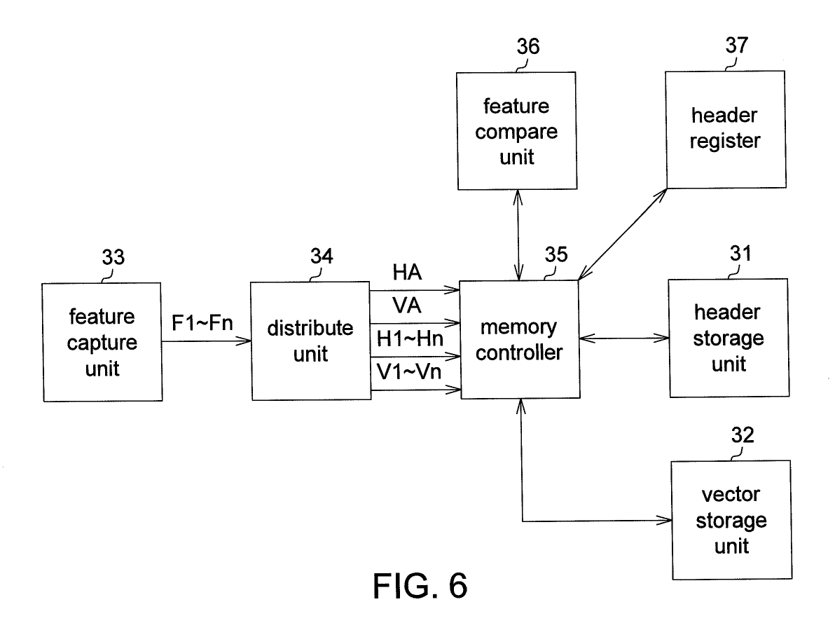

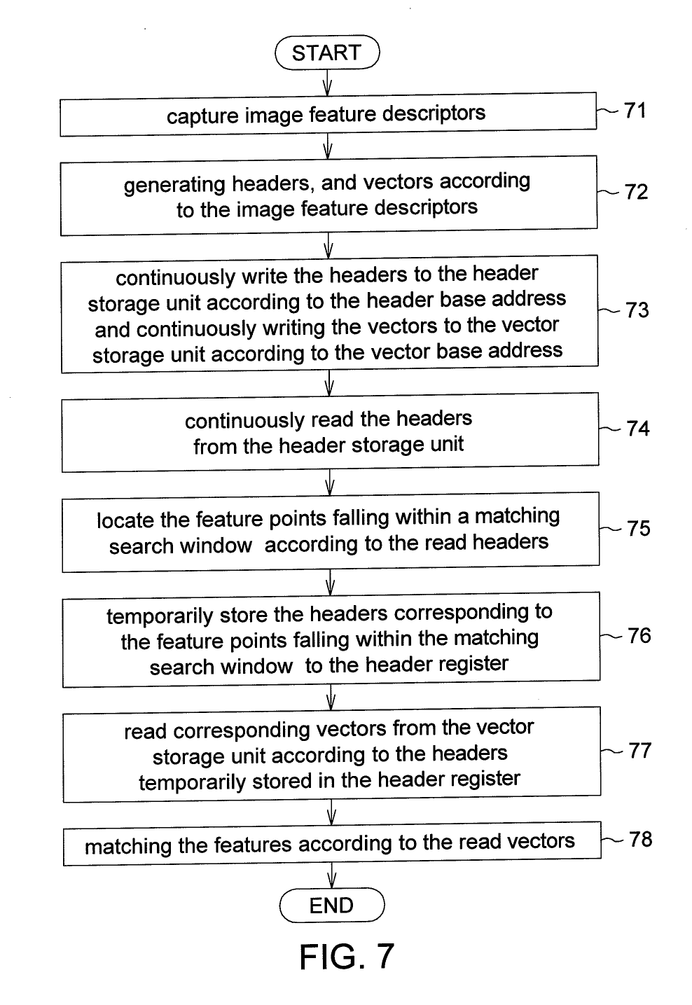

Referring to both FIG. 6 and FIG. 7. FIG. 6 shows block diagram of an apparatus for processing image feature descriptors according to a second embodiment. FIG. 7 shows a flowchart of a method for processing image feature descriptors according to a second embodiment. The image feature descriptor processing apparatus 6 is different from the image feature descriptor processing apparatus 3 mainly in that the image feature descriptor processing apparatus 6 further comprises a header register 37. The header register 37 is coupled to the memory controller 35 for temporarily storing the headers of the feature descriptors falling within the matching search window. When the image feature descriptor processing method can be used in the image feature descriptor processing apparatus 6, steps 71, 72, 73, 75 and 78 are similar to steps 51, 52, 53, 55 and 57, and the similarities are not repeated here.

As indicated in step 74, the memory controller 35 continuously reads the headers H1˜Hn from the header storage unit 31. As indicated in step 76, the memory controller 35 temporarily stores the headers corresponding to the feature points falling within the matching search window to the header register 37. Then, as indicated in step 77, the memory controller 35 reads the vectors of corresponding feature descriptors from the vector storage unit 32 according to the headers temporarily stored in the header register 37.

The image feature descriptor processing apparatus 6 firstly continuously reads the headers stored in the header storage unit 31 and then reads the vectors of the feature descriptors falling within the matching search window from the vector storage unit 32 according to the headers temporarily stored in the header register 37, so that the time for reading the headers is reduced and the feature matching speed is increased accordingly.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image feature descriptor processing apparatus, comprising:
a header storage unit;
a vector storage unit;
a feature capture unit used for capturing a plurality of image feature descriptors;
a distribute unit used for generating a header base address, a vector base address, a plurality of headers and a plurality of vectors according to the image feature descriptors; and
a memory controller used for continuously writing the headers to the header storage unit according to the header base address and continuously writing the vectors to the vector storage unit according to the vector base address.

2. The image feature descriptor processing apparatus according to claim 1, wherein the memory controller continuously reads at least a part of the headers from the header storage unit.

3. The image feature descriptor processing apparatus according to claim 2, further comprising:
a feature compare unit used for locating the feature points falling within a matching search window according to the read headers, wherein the memory controller reads the vectors corresponding to the feature points falling within the matching search window from the vector storage unit, and the feature compare unit further performs feature matching according to the read vectors.

4. The image feature descriptor processing apparatus according to claim 3, wherein the feature compare unit is integrated to the feature capture unit.

5. The image feature descriptor processing apparatus according to claim 1, wherein the memory controller continuously reads the headers from the header storage unit.

6. The image feature descriptor processing apparatus according to claim 5, further comprising:
a feature compare unit used for locating the feature points falling within a matching search window according to the read headers; and
a header register used for temporarily storing the headers corresponding to the feature points falling within the matching search window, wherein the memory controller reads corresponding vectors from the vector storage unit according to the headers temporarily stored in the header register, and the feature compare unit performs feature matching according to the read vectors.

7. The image feature descriptor processing apparatus according to claim 6, wherein the feature compare unit is integrated to the feature capture unit.

8. The image feature descriptor processing apparatus according to claim 1, wherein each header comprises a feature number and feature coordinates.

9. The image feature descriptor processing apparatus according to claim 1, wherein each vector comprises a gradient vector.

10. The image feature descriptor processing apparatus according to claim 1, wherein the header storage unit and the vector storage unit share the same dynamic random access memory (DRAM).

11. The image feature descriptor processing apparatus according to claim 1, wherein the distribute unit is integrated to the feature capture unit.

12. The image feature descriptor processing apparatus according to claim 1, wherein the distribute unit is integrated to the memory controller.

13. An image feature descriptor processing method, comprising:
capturing a plurality of image feature descriptors;
generating a header base address, a vector base address, a plurality of headers and a plurality of vectors according to the image feature descriptors; and
continuously writing the headers to a header storage unit according to the header base address and continuously writing the vectors to a vector storage unit according to the vector base address.

14. The image feature descriptor processing method according to claim 13, further comprising:
continuously reading at least a part of the headers from the header storage unit;
locating the feature points falling within a matching search window according to the read headers;
reading the vectors corresponding to the feature points falling within the matching search window from the vector storage unit; and
matching the features according to the read vectors.

15. The image feature descriptor processing method according to claim 13, further comprising:
continuously reading the headers from the header storage unit;
locating the feature descriptors falling within a matching search window according to the read headers;
temporarily storing the headers corresponding to the feature points falling within the matching search window to a header register;
reading corresponding vectors from the vector storage unit according to the headers temporarily stored in the header register; and
matching the features according to the read vectors.

16. The image feature descriptor processing method according to claim 13, wherein each header comprises a feature number and feature coordinates.

17. The image feature descriptor processing method according to claim 13, wherein each vector comprises a gradient vector.

18. The image feature descriptor processing method according to claim 13, wherein the header storage unit and the vector storage unit share the same dynamic random access memory (DRAM).
